(19) United States
(12) Patent Application Publication
(10) Pub. No.: US 2022/0205637 A1
(43) Pub. Date: Jun. 30, 2022

(54) MITIGATING COMBUSTION DYNAMICS USING VARYING LIQUID FUEL CARTRIDGES

(71) Applicant: General Electric Company, Schenectady, NY (US)

(72) Inventors: Wessam Estefanos, Simpsonville, SC (US); Hasan U. Karim, Greenville, SC (US)

(21) Appl. No.: 17/137,526

(22) Filed: Dec. 30, 2020

(51) Int. Cl. F23R 3/34; F02C 7/228

(52) U.S. Cl. CPC F23R 3/343; F02C 7/228; F05D 2260/964; F05D 2240/35; F05D 2250/232; F23R 2900/00014

(57) ABSTRACT

A method of operating a combustor in a turbomachine is provided. The method includes a step of injecting a first central flow of liquid fuel from each outer liquid fuel cartridge in the first group of outer liquid fuel cartridges into a combustion zone at a first central angle. A first group of outer liquid fuel cartridges includes a first pilot tip. A second group of outer liquid fuel cartridges includes a second pilot tip. The method further includes a step of injecting a second central flow of liquid fuel from each outer liquid fuel cartridge in the second group of outer liquid fuel cartridges into the combustion zone at a second central angle. The first central angle is different than the second central angle.

### FIELD

The present disclosure relates generally to a combustor and associated method of operation that mitigates combustion dynamics within a combustor of a turbomachine.

### BACKGROUND

Turbomachines are utilized in a variety of industries and applications for energy transfer purposes. For example, a gas turbine engine generally includes a compressor section, a combustion section, a turbine section, and an exhaust section. The compressor section progressively increases the pressure of a working fluid entering the gas turbine engine and supplies this compressed working fluid to the combustion section. The compressed working fluid and a fuel (e.g., natural gas) mix within one or more combustors of the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases then exit the gas turbine via the exhaust section.

Generally, combustors of the combustion section include multiple fuel nozzles, which extend downstream from an end cover of the combustor and which provide a mixture of fuel and compressed air to the combustion chamber. A liner or sleeve circumferentially surrounds a portion of the fuel nozzles and may at least partially define the combustion chamber. The liner may at least partially define a hot gas path for routing combustion gases from the primary combustion zone to an inlet of a turbine of the gas turbine.

During operation, various operating parameters such as fuel temperature, fuel composition, ambient operating conditions and/or operational load on the gas turbine may result in combustion dynamics or pressure pulses within the combustor. The combustion dynamics may cause oscillation of the various combustor hardware components such as the liner and/or the premix fuel nozzle which may result in undesirable wear of those components. As may be appreciated, mitigating combustion dynamics at target frequencies can advantageously increase the operational flexibility of the turbomachine.

Accordingly, a method and system for operating a combustor that mitigates combustion dynamics would be useful in the art. In particular, a method and system for operating a combustor that mitigates combustion dynamics at target frequencies, thereby allowing for greater operation flexibility of the turbomachine, would be useful.

### BRIEF DESCRIPTION

Aspects and advantages of the combustors and methods in accordance with the present disclosure will be set forth in part in the following description, or may be obvious from the description, or may be learned through practice of the technology.

In accordance with one embodiment, a method of operating a combustor in a turbomachine is provided. The combustor includes a plurality of outer fuel nozzles circumferentially arranged on an end cover. The combustor further includes a plurality of outer liquid fuel cartridges arranged in a first group of outer liquid fuel cartridges and a second group of outer liquid fuel cartridges. The method includes a step of injecting a first central flow of liquid fuel from each outer liquid fuel cartridge in the first group of outer liquid fuel cartridges into a combustion zone at a first central angle. Each outer liquid fuel cartridge in the plurality of outer liquid fuel cartridges extends from a respective flange coupled to the end cover through a respective outer fuel nozzle of the plurality of outer fuel nozzles to one of a first pilot tip or a second pilot tip. The first group of outer liquid fuel cartridges includes the first pilot tip. The second group of outer liquid fuel cartridges includes the second pilot tip. The method further includes a step of injecting a second central flow of liquid fuel from each outer liquid fuel cartridge in the second group of outer liquid fuel cartridges into the combustion zone at a second central angle. The first central angle is different than the second central angle.

In accordance with another embodiment, a combustor is provided. The combustor includes an end cover, a combustion liner defining a combustion chamber, and a plurality of outer fuel nozzles. The plurality of outer fuel nozzles are circumferentially arranged and extend between the end cover and the combustion liner. A plurality of outer liquid fuel cartridges are arranged in a first group and a second group. Each outer liquid fuel cartridge in the plurality of outer liquid fuel cartridges extending from a respective flange coupled to the end cover through a respective outer fuel nozzle of the plurality of outer fuel nozzles to one of a first pilot tip or a second pilot tip. The first group of outer liquid fuel cartridges include the first pilot tip and the second group of outer liquid fuel cartridges include the second pilot tip. The first pilot tip defines a first central outlet configured to eject liquid fuel into the combustion zone at a first central angle. The second pilot tip defines a second central outlet configured to eject liquid fuel into the combustion zone at a second central angle. The first central angle is different than the second central angle.

These and other features, aspects and advantages of the present combustors and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present combustors and methods, including the best mode of making and using the present systems and methods, directed to one of ordinary skill in the art, is set forth in the specification, which makes reference to the appended figures, in which:

FIG. 1 is a schematic illustration of a turbomachine, in accordance with embodiments of the present disclosure;

FIG. 2 illustrates a cross sectional view of a combustor, in accordance with embodiments of the present disclosure;

FIG. 3 illustrates a plan view of a combustor from along an axial centerline, in accordance with embodiments of the present disclosure;

FIG. 4 illustrates a cross-sectional view of a combustor from within the combustion chamber, in accordance with embodiments of the present disclosure;

FIG. 5 illustrates a cross-sectional view of a combustor from within the combustion chamber, in accordance with embodiments of the present disclosure;

FIG. 6 illustrates an outer liquid fuel cartridge having a first pilot tip, in accordance with embodiments of the present disclosure;

FIG. 7 illustrates a plan view of the first pilot tip of FIG. 6, in accordance with embodiments of the present disclosure;

FIG. 8 illustrates an outer liquid fuel cartridge having a second pilot tip, in accordance with embodiments of the present disclosure;

FIG. 9 illustrates a plan view of the second pilot tip of FIG. 8, in accordance with embodiments of the present disclosure; and

FIG. 10 illustrates a flow chart of a sequential set of steps that define a method operating a combustor in a turbomachine, in accordance with embodiments of the present disclosure.

### DETAILED DESCRIPTION

Reference now will be made in detail to embodiments of the present combustors and methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component. terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

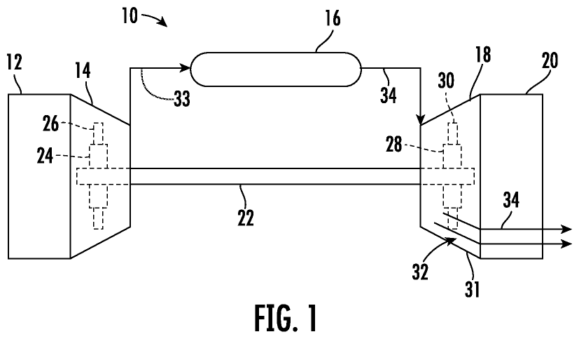

Referring now to the drawings, FIG. 1 illustrates a schematic diagram of one embodiment of a turbomachine, which in the illustrated embodiment is a gas turbine 10. Although an industrial or land-based gas turbine is shown and described herein, the present disclosure is not limited to a land based and/or industrial gas turbine unless otherwise specified in the claims. For example, the invention as described herein may be used in any type of turbomachine including but not limited to a steam turbine, an aircraft gas turbine, or a marine gas turbine.

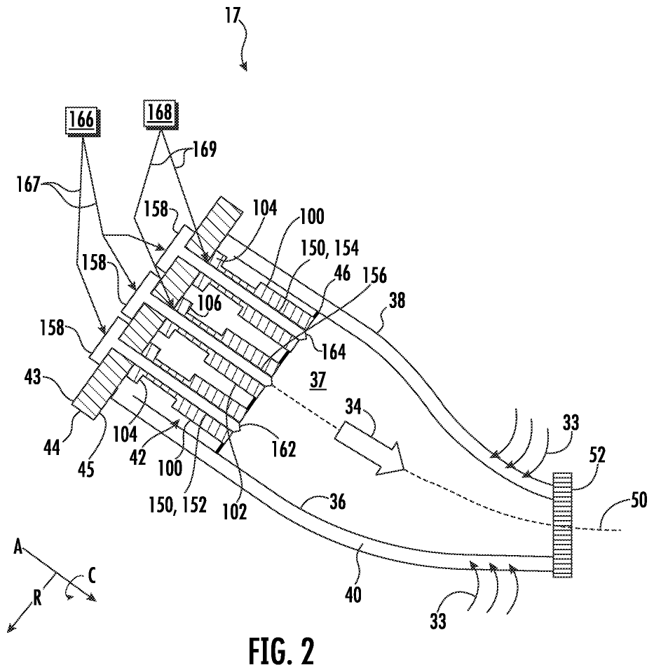

As shown, gas turbine 10 generally includes an inlet section 12, a compressor section 14 disposed downstream of the inlet section 12, a plurality of combustors 17 (FIG. 2) within a combustor section 16 disposed downstream of the compressor section 14, a turbine section 18 disposed downstream of the combustor section 16, and an exhaust section 20 disposed downstream of the turbine section 18. Additionally, the gas turbine 10 may include one or more shafts 22 coupled between the compressor section 14 and the turbine section 18.

The compressor section 14 may generally include a plurality of rotor disks 24 (one of which is shown) and a plurality of rotor blades 26 extending radially outwardly from and connected to each rotor disk 24. Each rotor disk 24 in turn may be coupled to or form a portion of the shaft 22 that extends through the compressor section 14.

The turbine section 18 may generally include a plurality of rotor disks 28 (one of which is shown) and a plurality of rotor blades 30 extending radially outwardly from and being interconnected to each rotor disk 28. Each rotor disk 28 in turn may be coupled to or form a portion of the shaft 22 that extends through the turbine section 18. The turbine section 18 further includes an outer casing 31 that circumferentially surrounds the portion of the shaft 22 and the rotor blades 30, thereby at least partially defining a hot gas path 32 through the turbine section 18.

During operation, a working fluid such as air flows through the inlet section 12 and into the compressor section 14 where the air is progressively compressed, thus providing pressurized or compressed air 33 to the combustors of the combustor section 16. The compressed air 33 is mixed with fuel and burned within each combustor to produce combustion gases 34. The combustion gases 34 flow through the hot gas path 32 from the combustor section 16 into the turbine section 18, wherein energy (kinetic and/or thermal) is transferred from the combustion gases 34 to the rotor blades 30, causing the shaft 22 to rotate. The mechanical rotational energy may then be used to power the compressor section 14 and/or to generate electricity. The combustion gases 34 exiting the turbine section 18 may then be exhausted from the gas turbine 10 via the exhaust section 20.

FIG. 2 illustrates a cross sectional view of a combustor 17 in the plurality of combustors 17, in accordance with embodiments of the present disclosure. As shown, the combustor 17 defines an axial direction A, a radial direction R, and a circumferential direction C. In general, the axial direction A extends parallel to an axial centerline 50 of the combustor 17, the radial direction R extends generally orthogonal to the axial centerline 50, and the circumferential direction C extends generally concentrically around the axial centerline 50.

As shown, the combustor 17 includes a liner 36 that contains and conveys combustion gases 34 to the turbine. The liner 36 may define a combustion chamber 37 within which combustion occurs. The liner 36 may have a cylindrical liner portion and a tapered transition portion that is separate from the cylindrical liner portion, as in many conventional combustion systems. Alternately, the liner 36 may have a unified body (or “unibody”) construction, in which the cylindrical portion and the tapered portion are integrated with one another. Thus, any discussion herein of the liner 36 is intended to encompass both conventional combustion systems having a separate liner and transition piece and those combustion systems having a unibody liner. Moreover, the present disclosure is equally applicable to those combustion systems in which the transition piece and the stage one nozzle of the turbine are integrated into a single unit, sometimes referred to as a “transition nozzle” or an “integrated exit piece.”

In many embodiments, the liner 36 may be surrounded by an outer sleeve 38, which is spaced radially outward of the liner 36 to define an annulus 40 between the liner 36 and the outer sleeve 38. The outer sleeve 38 may include a flow sleeve portion at the forward end and an impingement sleeve portion at the aft end, as in many conventional combustion systems. Alternately, the outer sleeve 38 may have a unified body (or “unisleeve”) construction, in which the flow sleeve portion and the impingement sleeve portion are integrated with one another in the axial direction. As before, any discussion herein of the outer sleeve 38 is intended to encompass both conventional combustion systems having a separate flow sleeve and impingement sleeve and combustion systems having a unisleeve outer sleeve.

The combustor 17 may further include a head end portion 42 that is located upstream from the combustion zone and that surrounds a plurality of fuel nozzles 100, 102. For example, the head end portion 42 may be defined between an end cover 44 and a cap plate 46 of the combustor 17. The end cover 44 may generally cover the forward end of the combustor 17 and may include a forward surface 43 and an aft surface 45. In many embodiments, a plurality of outer fuel nozzles 100 may circumferentially surround a center fuel nozzle 102 within the head end portion 42. The fuel nozzles 100, 102 may each extend between the end cover 44 and the cap plate 46. For example, the fuel nozzles 100, 102 may each extend from a respective flange 104, 106 coupled to the aft surface 45 of the end cover 44, through the cap plate 46, to a respective outlet disposed in the combustion chamber 37. As described below, the fuel nozzles 100, 102 shown in FIG. 2 may be swirler fuel nozzles 400, 402 (FIG. 4), bundled tube fuel nozzles 500 (FIG. 5), or any other suitable fuel nozzle.

In exemplary embodiments, a plurality of outer liquid fuel cartridges 150 may be arranged in a first group 152 of outer liquid fuel cartridges 150 and a second group 154 of outer liquid fuel cartridges 150. As shown, the plurality of outer liquid fuel cartridges 150 may be at least partially disposed within the head end portion 42. As shown in FIG. 2, each outer liquid fuel cartridge 150 in the plurality of outer liquid fuel cartridges 150 may extend through a respective outer fuel nozzle 100, such that the ratio of outer fuel nozzles 100 to outer liquid fuel cartridges 150 is 1:1. In other embodiments, the ratio of outer fuel nozzles 100 to outer liquid fuel cartridges 150 may be greater than or less than 1. In many embodiments, each outer liquid fuel cartridge 150 may extend coaxially with a respective outer fuel nozzle 100, such that the outer liquid fuel cartridges 150 are circumferentially spaced apart from one another and generally surround an axial centerline 50 of the combustor 17.

In some embodiments, as shown in FIG. 2, the combustor 17 may further include a center liquid fuel cartridge 156 that extends through the center fuel nozzle 102, in order to provide an additional flow of liquid fuel to the combustion chamber 37. For example, the center liquid fuel cartridge may extend coaxially with both the center fuel nozzle 102 and the axial centerline 50 of the combustor 17. In such embodiments, the plurality of outer fuel cartridges 150 may circumferentially surround the outer fuel cartridge 152. In other embodiments, the combustor 17 may not include a center liquid fuel cartridge 156, such that the combustor 17 only includes the outer liquid fuel cartridges 150.

In many embodiments, each outer liquid fuel cartridge 150 may extend from a respective flange 158 coupled to the end cover 44, through a respective outer fuel nozzle 100 of the plurality of outer fuel nozzles 100, to one of a first pilot tip 162 or a second pilot tip 164. For example, the flange 158 of each outer liquid fuel cartridge 150 may couple to the forward surface 43 of the end cover 44 (opposite the flange 104 of the outer fuel nozzles 100. As shown in FIGS. 2, 4, and 5, the outer liquid fuel cartridges 150 belonging to the first group 152 include the first pilot tip 162 and the liquid fuel cartridges 150 belonging to the second group 154 include the second pilot tip 164. As discussed further below, the first pilot tip 162 and the second pilot tip 164 may each be configured to inject liquid fuel within the combustion chamber 37 at different angles relative to one another, which has been demonstrated to reduce combustion dynamics (or pressure pulsations) within the combustor 17 at target frequencies (such as approximately 150 Hz and/or approximately 260 Hz). In this way, utilizing two different pilot tips 162, 164 in the manner and arrangement described herein has been shown to increase the operable window of the entire gas turbine 10, which results in increased efficiency and decreased emissions.

As shown in FIG. 2, each of the liquid fuel cartridges 150, 156 may be fluidly coupled to a liquid fuel supply 166, such that the liquid fuel cartridges convey liquid fuel through the head end 42 to the combustion chamber 37. As shown, the liquid fuel supply 166 may be fluidly coupled to the liquid fuel cartridges 150, 156 via a liquid fuel supply line 167. In many embodiments, the pure liquid fuel may be supplied from the liquid fuel supply 166 to the liquid fuel cartridges 150 and/or 156 for injection into the combustion chamber 37. In other embodiments, the liquid fuel cartridges 150 and/or 156 may be supplied with a liquid fuel mixture (such as a mixture of pure liquid fuel and water) from the liquid fuel supply 166. The liquid fuel mixture may originate from a liquid fuel supply system (such as a mixing tank) within which liquid fuel and water are mixed and delivered to the liquid fuel cartridges 150, 156 via the liquid fuel supply line 167.

As may be appreciated, supplying a water/fuel mixture to the liquid fuel cartridges 150 may advantageously reduce emissions from the combustion process, e.g., may reduce the emissions of nitrogen oxides (NOx) from the combustor 17. In this way, it is desirable for the combustor 17 to be able to operate on a wide range of water/liquid fuel mixtures without creating combustion dynamic issues within the combustor 17. The combustor 17, and specifically the mixed pilot nozzles 162, 164, described herein may advantageously reduce the combustion dynamics within the combustor 17 and may be capable of operation using a wider range of water to fuel ratio (e.g. such as up to 1.6 in some embodiments), which is an improvement over prior designs. The capability of the combustor 17 to operate using a wider range of water to fuel allows the combustor 17 to meet different site requirements, specifically requirements regarding low emission of NOx and/or limited consumption of water.

In many embodiments, as shown in FIG. 2, the fuel nozzles 100, 102 may be fluidly coupled to a gaseous fuel supply 168 via a gaseous fuel supply line 169. In this way, each of the fuel nozzles 100, 102 may be in fluid communication with the gaseous fuel supply 168, such that the fuel nozzles 100, 102 convey gaseous fuel from the gaseous fuel supply 168, through the head end portion 42, to the combustion chamber 37. The gaseous fuel may be mixed with compressed air 33 within the fuel nozzles 100, 102 prior to injection into the combustion chamber 37 by the fuel nozzles 100, 102. As described below, the fuel nozzles 100, 102 may be swirler fuel nozzles 400, 402, bundled tube fuel nozzles 500, or any other suitable fuel nozzle.

In many embodiments, the head end portion 42 of the combustor 17 may be at least partially surrounded by a forward casing, which is physically coupled and fluidly connected to a compressor discharge case. In various embodiments, the compressor discharge case may be fluidly connected to an outlet of the compressor 14 and define a pressurized air plenum that surrounds at least a portion of the combustor 17. Compressed air 33 may flow from the pressurized air plenum into the annulus 40 at an aft end of the combustor 17, via openings defined in the outer sleeve 38. Because the annulus 40 is fluidly coupled to the head end portion 42, the air flow 26 travels upstream from the aft end of the combustor 17 to the head end portion 42, where the air flow 26 reverses direction and enters the fuel nozzles 100. For example, the air 26 may travel through the annulus 40 in the opposite direction of the combustion gases 34 within the liner 36.

In one embodiment, the fuel 28 and air 26 are mixed within the fuel nozzles 100 (e.g., in a premixed fuel nozzle). In other embodiments, the fuel 28 and air 26 may be separately introduced into the combustion chamber 37 and mixed within the combustion chamber 37 (e.g., as may occur with a diffusion nozzle). Reference made herein to a “fuel/air mixture” should be interpreted as describing both a premixed fuel/air mixture and a diffusion-type fuel/air mixture, either of which may be produced by the fuel nozzles 100.

The combustion gases 34, which are produced by combusting gaseous fuel 28 and/or liquid fuel 58 with compressed air 33, travel downstream toward an aft frame 52 of the combustor 17, the aft frame 52 representing an aft end of the combustor 17. In many embodiments, the aft frame 52 may be connected to the turbine 18, such that the combustion gases 34 may exit the combustor section 16 at the aft frame 52 and enter the turbine 18.

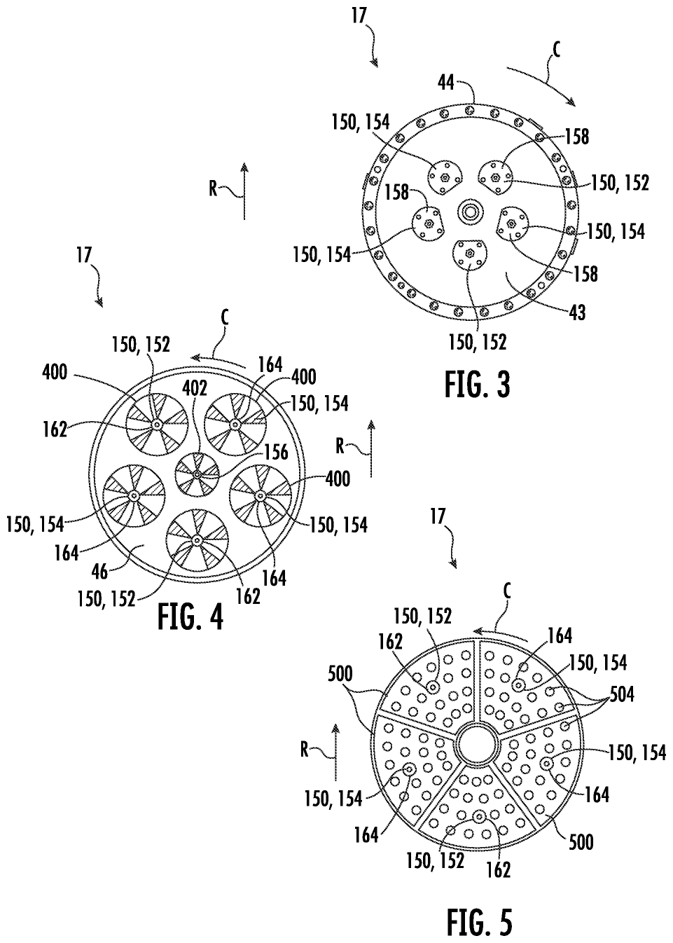

FIG. 3 illustrates a plan view of the combustor 17 from along the axial centerline 50, e.g., the forward surface 43 of the end cover 44 of the combustor 17, in accordance with embodiments of the present disclosure. As shown in FIG. 3, the plurality of outer liquid fuel cartridges 150 may be circumferentially spaced apart from one another (e.g. equally spaced apart in some embodiments) and may each be disposed at a common radial distance from the axial centerline 50 of the combustor 17. In this way, the plurality of liquid fuel cartridges 150 may each be positioned along a common circular axis defined on the forward surface 43 and extending around the axial centerline 50 of the combustor 17. For example, the plurality of outer liquid fuel cartridges 150 may consist of an array of outer liquid fuel cartridges 150 (such as five outer liquid fuel cartridges 150) positioned equidistant from center of the end cover 44 (and/or the axial centerline 50 of the combustor 17) and equally circumferentially spaced from center of the end cover 44. In this way, no two outer liquid fuel cartridges 150 are colinear along a line that extends along the forward surface 43 of the end cover 44 through the center of the end cover 44 (and/or the axial centerline 50).

FIG. 3 shows the outer liquid fuel cartridges 150 belonging to the first group 152 and the second group 154. As discussed above, the outer liquid fuel cartridges 150 belonging to the first group 152 may include a first pilot tip 162 (FIGS. 4 and 5), and the outer liquid fuel cartridges 150 belonging to the second group 152 may include a second pilot tip 164 (FIGS. 4 and 5). That is, the first group and the second group 154 of outer liquid fuel cartridges may be configured to inject liquid fuel within the combustion chamber 37 at different angles, which has been proven to reduce combustion dynamics within the combustor 17 at target frequencies. The arrangement and numbering of the first group 152 and second group 154 of outer liquid fuel cartridges 150 shown in FIG. 3 may be particularly advantageous for mitigating combustion dynamics, e.g., two outer liquid fuel cartridges 150 belonging to the first group 152 and three liquid fuel cartridges 150 belonging to the second group 154. However, other arrangements and numberings of the first group 152 and the second group 154 of outer liquid fuel cartridges 150 may be possible, e.g., one outer liquid fuel cartridge 150 in the first group 152 and four in the second group 154 (or any other combination).

As shown in FIG. 3, each outer liquid fuel cartridge 150 in the first group 152 of outer liquid fuel cartridges may circumferentially neighbor at least one outer liquid fuel cartridge 150 in the second group 154 of outer liquid fuel cartridges 150. For example, each outer liquid fuel cartridge 150 in the first group 152 of outer liquid fuel cartridges 150 may directly circumferentially neighbor two outer liquid fuel cartridges 150 in the second group 154, such that no two outer liquid fuel cartridges 150 in the first group 152 circumferentially neighbor each other (although this may occur in alternative embodiments).

In particular, since there are only two outer liquid fuel cartridges 150 in the first group 152 and only three in the second group 154 in the FIG. 3 embodiment, each outer liquid fuel cartridge 150 in the first group 152 may directly circumferentially neighbor two outer liquid fuel cartridges 150 in the second group 154. The arrangement and numbering of the outer liquid fuel cartridges 150 of each group 152, 154 shown in FIG. 3 and described above has been tested and shown to be particularly advantageous for mitigating combustion dynamics (or pressure pulses) within the combustor at target frequencies, thereby increasing the operational flexibility of the gas turbine 10.

FIG. 4 illustrates cross-sectional views of a combustor 17 from within the combustion chamber 37, in which swirling fuel nozzles are utilized. As shown, the plurality of outer liquid fuel cartridges 150 may be installed coaxially with the plurality of outer fuel nozzles, which are shown as outer swirling fuel nozzles 400 or “swozzles” in FIG. 4. Similarly, the center liquid fuel cartridge 156 may extend coaxially with the center fuel nozzle 102, which may be a center swirling fuel nozzle 402. As shown in FIG. 4 each swirling fuel nozzle 400, 402 may include swirling vanes 404 that impart a swirling direction to air flowing therethrough. In some embodiments, the swirling vanes 404 of the outer fuel nozzles 400 are disposed about the respective outer liquid fuel cartridge 150. In Although five outer swirling fuel nozzles 400 are shown, it should be understood that other numbers of outer swirling fuel nozzles 400 may be employed (such as 4, 6, or 8 fuel nozzles 400). The fuel nozzles 400, 402 may be installed within corresponding openings (not separately labeled) in the combustor cap 46.

FIG. 5 illustrates a cross-sectional view of an alternative embodiment of the combustor 17 from within the combustion chamber 37, in which bundled tube fuel nozzles are utilized. As shown in FIG. 5, the plurality of outer liquid fuel cartridges 150 may be installed coaxially with the plurality of outer fuel nozzles, which are shown as outer bundled tube fuel nozzles 500. Similarly, a center liquid fuel cartridge may extend coaxially with a center bundled tube fuel nozzle (not shown). Each bundled tube fuel nozzle 500 includes a plurality of individual premixing tubes 504 within which fuel and air are mixed. The premixing tubes 504 extend through an aft plate 506, which may be unique to each bundled tube fuel nozzle 500, or which may extend across all the bundled tube fuel nozzles. The bundled tube fuel nozzles 500 may include an upstream fuel plenum, and each premixing tube 504 may include one or more fuel injection ports in fluid communication with the fuel plenum. Air flowing through an inlet end of each premixing tube 504 mixes with fuel flowing through the fuel injection port(s), and a mixture of fuel and air is conveyed through an outlet end of each tube 504.

Although the outer bundled tube fuel nozzles 500 are shown as having a sector shape that includes two radially extending sides and two oppositely disposed arcuate sides, it should be understood that the outer bundled tube fuel nozzles 500 may have any shape or size.

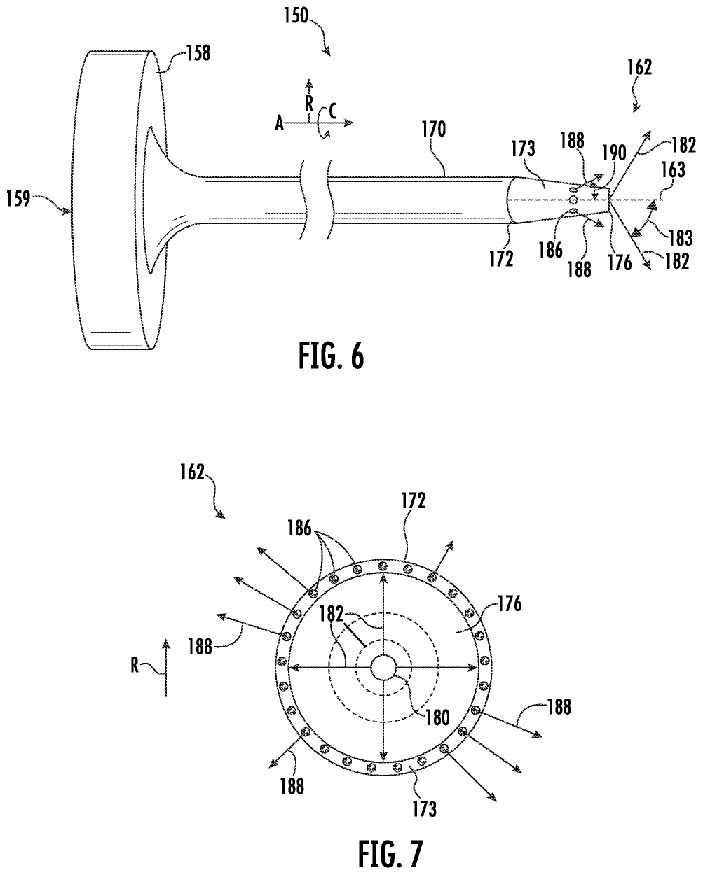

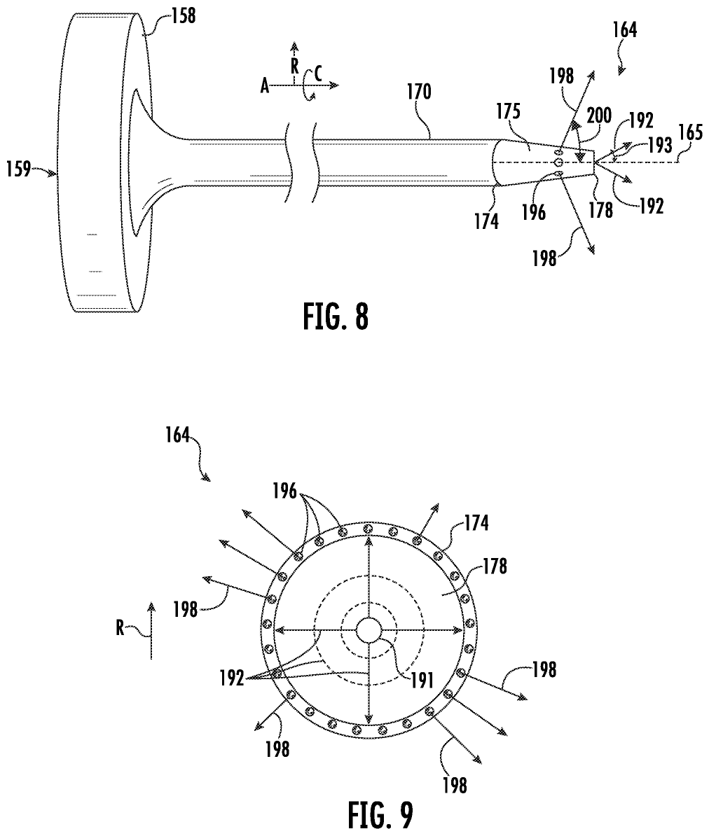

FIG. 6 illustrates an outer liquid fuel cartridge 150 having a first pilot tip 162 (therefore belonging to the first group 152 as discussed above), and FIG. 7 illustrates the first pilot tip 162 of the outer liquid fuel cartridge 150 shown in FIG. 6 as viewed from slightly downstream looking upstream, in accordance with embodiments of the present disclosure. Similarly, FIG. 8 illustrates an outer liquid fuel cartridge 150 having a second pilot tip 164 (therefore belonging to the second group 154 as discussed above), and FIG. 9 illustrates the second pilot tip 164 of the outer liquid fuel cartridge 150 shown in FIG. 8 as viewed from slightly downstream looking upstream, in accordance with embodiments of the present disclosure.

As shown in both FIGS. 6 and 8, each outer liquid fuel cartridge 150 may include a cylindrical body 170, and a flange 158 that defines an inlet 159 that receives the liquid fuel (or liquid fuel and water mixture) from the liquid fuel supply line 167 (FIG. 2). As discussed above, the flange 158 may couple the outer liquid fuel cartridge 150 to the forward surface 43 of the end cover 44. The cylindrical body 170 of the outer liquid fuel cartridges may extend from the flange 158, through a respective outer fuel nozzle 100 (FIG. 2), to one of the first pilot tip 162 (FIG. 6) or the second pilot tip 164 (FIG. 8).

For example, the pilot tips 162, 164 may each extend directly from the cylindrical body 170 of the outer liquid fuel cartridge 150. In various embodiments, the pilot tips 162, 164 may be positioned either partially or entirely within the combustion zone 37 (FIG. 2). many embodiments, each of the pilot tips 162, 164 may include a respective base 172, 174 that directly couples to the cylindrical body 170, such that the base 172, 174 is the axially innermost portion of the pilot tips 162, 164 with respect to the axial direction A.

The pilot tips 162, 164 may diverge radially inward from the respective base 172, 174 to an aft surface 176, 178, such that the pilot tips 162, 164 have a generally frustoconical shape. For example, the pilot tips 162, 164 may each include a body 173, 175 that extends between the respective base 172, 176, and the respective aft face 176, 178. The frustoconical shape of the pilot tips 162, 164 may be advantageous over, e.g., a cylindrical shape such that it provides an aerodynamic contour that minimizes the potential for fuel vortices or hot spots along the pilot tips 162, 164. In various embodiments, as shown best in FIG. 2, the pilot tips 162, 164 may be disposed entirely within the combustion chamber 37 and terminate at the respective aft surfaces 176, 178, which are positioned downstream from the combustor cap 46.

In many embodiments, the pilot tips 162, 164 may each define a respective axial centerline 163, 165 that are each parallel to the axial direction A of the combustor 17 when installed.

As shown in FIGS. 6 and 7, the first pilot tip 162 may define a first central outlet 180 configured to eject a first central flow 182 of liquid fuel (or a liquid fuel and water mixture) into the combustion zone 37 at a first central angle 183. The first central outlet 180 may be a circularly shaped hole that has a center point along the axial centerline 163 of the pilot tip 162. The first central flow 182 that is ejected from the first central outlet 180 may be in the form of a singular conical spray of liquid fuel (or a liquid fuel and water mixture). For example, as opposed to being a jetted spray of fuel, the first central flow 182 is a continuous conical stream that diverges radially from the central outlet 180 as it travels in the axial direction A. For example, there is no break in the first central flow 182 circumferentially around the axial centerline 163 (due to the continuous conical spray), such that the first central angle 183 is continuously defined in the circumferential direction between an interior of the first central flow 182 and the axial centerline 163 (as shown by the dashed lines connecting the arrows 182 in FIG. 7).

In exemplary embodiments, first central angle 183 may be defined between the axial centerline 163 of the first pilot tip 162 (and/or the axial direction of the combustor 17 when installed) and the first central flow 182 of liquid fuel exiting the central outlet 180. In many embodiments, the first central angle 183 may be between about 35° and about 45°. In other embodiments, the first central angle 183 may be between about 38° and about 45°. In some embodiments, the first central angle 183 may be between about 40° and about 45°. In particular embodiments, the first central angle 183 may be and about 45° (exactly 45° in some embodiments). The degree of the first central angle 183 disclosed herein have been tested and proved to advantageously mitigate combustion dynamics within the combustor 17 while providing adequate fuel for the combustion process and without creating hot spots.

In many embodiments, as shown in FIGS. 6 and 7, the first pilot tip 162 may further define a plurality of first peripheral outlets 186 that surround the first central outlet 180 of the first pilot tip 162. For example, the plurality of first peripheral outlets 186 may be spaced apart (e.g. equally spaced apart) circumferentially from one another and disposed on the body 173 of the first pilot tip 162. Each peripheral outlet 186 may be configured to eject a first jetted flow 188 of liquid fuel into the combustion chamber 37 at a first jetted angle 190. As shown in FIG. 6, the first jetted angle 190 may be smaller than the first central angle 183 of the first central flow 182, such that the jetted flow 188 must pass through the central flow when ejecting fuel from both the first central outlet 180 and the peripheral outlets 186 at the same time.

The first jetted flow 188 exiting each of the peripheral outlets 186 may be in the form of a discrete jet of liquid fuel (or liquid fuel mixed with water), such that a singular stream of liquid exits each of the outlets 186 at the jetted angle 190. In this way, the jetted flow 188 may not be continuous in the circumferential direction, but rather isolated non-intersecting streams of liquid exiting each of the peripheral outlets 186. In contrast, the central flow 182 may be a singular spray of liquid exiting the central outlet 180 that is continuous in the circumferential direction.

In exemplary embodiments, the jetted angle 190 may be defined between the axial centerline 163 of the first pilot tip 162 (and/or the axial direction of the combustor 17 when installed) and the first jetted flow 188 of liquid fuel (or liquid fuel mixed with water) exiting the peripheral outlets 186. For example, in some embodiments the first jetted angle 190 may be between about 45° and about 65°. In other embodiments, the first jetted angle 190 may be between about 50° and about 62°. In various embodiments, the first jetted angle 190 may be between about 53° and about 60°. The degree of the first jetted angle 190 disclosed herein have been tested and proved to advantageously mitigate combustion dynamics within the combustor 17 while providing adequate fuel for the combustion process and without creating hot spots.

As shown in FIGS. 8 and 9, the second pilot tip 164 may define a second central outlet 191 configured to eject a second central flow 192 of liquid fuel (or a liquid fuel and water mixture) into the combustion zone 37 at a second central angle 193. The second central outlet 191 may be a circularly shaped hole that has a center point along the axial centerline 165 of the second pilot tip 164. The second central flow 192 that is ejected from the second central outlet 191 may be in the form of a singular conical spray of liquid fuel (or a liquid fuel and water mixture). For example, as opposed to being a jetted spray of fuel, the second central flow 192 is a continuous conical stream that diverges radially from the central outlet 180 as it travels in the axial direction A. For example, there is no break in the central flow 192 circumferentially around the axial centerline 165 (due to the continuous conical spray), such that the second central angle 193 is continuously defined in the circumferential direction between an interior of the second central flow 192 and the axial centerline 165 (as shown by the dashed lines connecting the arrows 192 in FIG. 9).

In exemplary embodiments, second central angle 193 may be defined between the axial centerline 165 of the second pilot tip 164 (and/or the axial direction of the combustor 17 when installed) and the second central flow 192 of liquid fuel exiting the central outlet 191. In many embodiments, the second central angle 193 may be between about 20° and about 37.5°. In other embodiments, the second central angle 193 may be between about 25° and about 35°. In some embodiments, the second central angle 193 may be between about 30° and about 35°. In particular embodiments, the second central angle 193 may be and about 33° (exactly 33° in some embodiments). The degree of the second central angle 193 disclosed herein have been tested and proved to advantageously mitigate combustion dynamics within the combustor 17 while providing adequate fuel for the combustion process and without creating hot spots.

In exemplary embodiments, the first central angle 183 of the first central flow 182 exiting the first pilot tips 162 of the outer liquid fuel cartridges 150 belonging to the first group 152 may be different than the second central angle 193 of the second central flow 192 exiting the second pilot tips 164 of the outer liquid fuel cartridges 150 belonging to the second group 154. For example, in particular embodiments, the first central angle 183 may be larger than the second central angle 193, which advantageously reduces combustion dynamics when the pilot tips 162, 164 are arranged in the manner shown in FIGS. 3-5. For example, having varying injection angles of liquid fuel at varying locations within the combustor as shown and described above allows for increased mixing within the combustion chamber 37, which reduces the effects of combustion dynamics (or pressure pulsations) within the combustor 17.

In many embodiments, as shown in FIGS. 8 and 9, the second pilot tip 164 may further define a plurality of second peripheral outlets 196 that surround the second central outlet 191 of the second pilot tip 164. For example, the plurality of second peripheral outlets 186 may be spaced apart (e.g. equally spaced apart) circumferentially from one another and disposed on the body 175 of the second pilot tip 164. Each peripheral outlet 186 may be configured to eject a second jetted flow 198 of liquid fuel into the combustion chamber 37 at a second jetted angle 200. As shown in FIG. 8, the second jetted angle 200 may be generally larger than the second central angle 193 of the second central flow 192.

The second jetted flow 198 exiting each of the second peripheral outlets 196 may be in the form of a discrete jet of liquid fuel (or liquid fuel mixed with water), such that a singular stream of liquid exits each of the outlets 196 at the second jetted angle 200. In this way, the second jetted flow 198 may not be continuous in the circumferential direction, but rather isolated non-intersecting streams of liquid exiting each of the second peripheral outlets 196. In contrast, the second central flow 192 may be a singular spray of liquid fuel exiting the central outlet 191 that is continuous in the circumferential direction.

In exemplary embodiments, the second jetted angle 200 may be defined between the axial centerline 165 of the second pilot tip 164 (and/or the axial direction of the combustor 17 when installed) and the second jetted flow 198 of liquid fuel (or liquid fuel mixed with water) exiting the peripheral outlets 196. For example, in some embodiments the second jetted angle 200 may be between about 65° and about 85°. In other embodiments, the second jetted angle 200 may be between about 67° and about 83°. In various embodiments, the second jetted angle 200 may be between about 69° and about 81°. In particular embodiments, the second jetted angle 200 may be between about 73° and about 76°. In specific embodiments, the second jetted angle 200 may be between about 75°. The degree of the second jetted angle 200 disclosed herein have been tested and proved to advantageously mitigate combustion dynamics within the combustor 17 while providing adequate fuel for the combustion process and without creating hot spots.

In exemplary embodiments, the first jetted angle 190 of the first jetted flow 188 exiting the first pilot tip 162 of the outer liquid fuel cartridges 150 belonging to the first group 152 may be different than the second jetted angle 200 of the second jetted flow 198 exiting the second pilot tip 164 of the outer liquid fuel cartridges 150 belonging to the second group 154. For example, in particular embodiments, the first jetted angle 190 may be smaller than the second jetted angle 200, which advantageously reduces combustion dynamics when the pilot tips 162, 164 are arranged in the manner shown in FIGS. 3-5. For example, having varying injection angles of liquid fuel at varying locations within the combustor as shown and described above allows for increased mixing within the combustion chamber 37, which reduces the effects of combustion dynamics (or pressure pulsations) within the combustor 17.

Likewise, the first central angle 183, the second central angle 193, the first jetted angle 190, and the second jetted angle 200 each be different from one another. This may allow for increased mixing within the combustor when the pilot tips 162, 164 are arranged in the manner shown in FIGS. 2-5 (partially alternating between first pilot tip 162 and second pilot tip 164 in circumferential direction). In addition, the varying angles 183, 193, 190, and 200 decrease the combustion dynamics within the combustor 17 at target frequencies, thereby allowing for a greater range of operation. In addition, the varying injection angles allow the combustor 17 to be able to operate on a wider range of water/liquid fuel mixtures without creating combustion dynamic issues within the combustor 17. The combustor 17, and specifically the mixed pilot nozzles 162, 164, described herein may advantageously reduce the combustion dynamics within the combustor 17 and may be capable of operation using a wider range of water to fuel ratio (e.g. such as up to 1.6 in some embodiments), which is an improvement over prior designs.

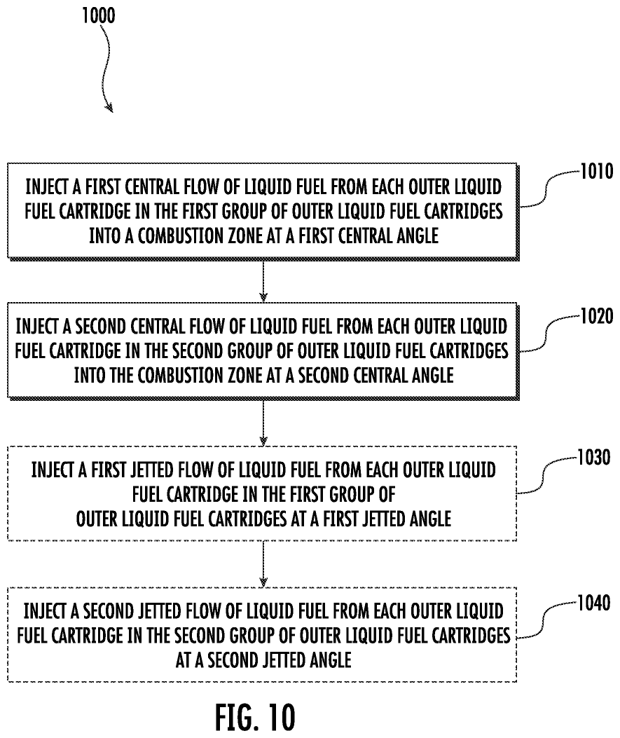

FIG. 10 is a flow chart of a sequential set of steps 1010 through 1040, which define a method 100 operating a combustor in a turbomachine, according to an embodiment of the present disclosure. As discussed in detail above, the combustor 17 includes a plurality of outer fuel nozzles 1000 circumferentially arranged on an end cover 44 and a plurality of outer liquid fuel cartridges 150 arranged in a first group 152 of outer liquid fuel cartridges 150 and a second group 154 of outer liquid fuel cartridges 154.

The method 1000 may include an initial step 1010 of injecting a first central flow 182 of liquid fuel from each outer liquid fuel cartridge 150 in the first group 152 of outer liquid fuel cartridges 150 into a combustion zone 37 at a first central angle 183. As discussed above, the first central flow 182 of liquid fuel (or a liquid fuel and water mixture) may be ejected from the first group 152 of outer liquid fuel cartridges 150 at a first pilot tip 162 (which may be disposed at least partially within the combustion chamber 37). In many embodiments, the liquid fuel (or liquid fuel and water mixture) may be supplied to the first group 152 of outer liquid fuel cartridges by a liquid fuel supply 166, which may be fluidly coupled to the outer liquid fuel cartridges via a liquid fuel supply line 167.

As shown in FIG. 10, the method 1000 may further include a step 1020 of injecting a second central flow 192 of liquid fuel from each outer liquid fuel cartridge 150 in the second group 154 of outer liquid fuel cartridges 150 into the combustion zone 37 at a second central angle 193. the second central flow 192 of liquid fuel (or a liquid fuel and water mixture) may be ejected from the second group 154 of outer liquid fuel cartridges 150 at a second pilot tip 164 (which may be disposed at least partially within the combustion chamber 37). In many embodiments, the liquid fuel (or liquid fuel and water mixture) may be supplied to the second group 154 of outer liquid fuel cartridges 150 by a liquid fuel supply 166, which may be fluidly coupled to the outer liquid fuel cartridges 150 via a liquid fuel supply line 167

In exemplary embodiments, the first central angle 183 may different than the second central angle 193. The varying injection angles (e.g. the central angles 183, 193 of the central flow 182, 192 of liquid fuel) allow the combustor 17 to be able to operate on a wider range of water/liquid fuel mixtures without creating combustion dynamic issues within the combustor 17. The combustor 17, and specifically the mixed pilot nozzles 162, 164, described herein may advantageously reduce the combustion dynamics within the combustor 17 and may be capable of operation using a wider range of water to fuel ratio (e.g. such as up to 1.6 in some embodiments), which is an improvement over prior designs.

In many embodiments, the step 1010 and the step 1020 may occur simultaneously, such that a first central flow 182 of liquid fuel is injected into the combustion chamber 37 by the first group 152 and a second central flow 192 is injected into the combustion chamber 37 by the second group 154 at the same time.

The outer liquid fuel cartridges 150 may be arranged such that they generally alternate between the first pilot tip 162 and the second pilot tip 164 in the circumferential direction C. In this way, the angle at which the central flows 182, 192 are exiting the liquid fuel cartridges 150 may be non-uniform in the circumferential direction, which advantageously reduced combustion dynamics and increased mixing of the liquid fuel during combustion. For example, each outer liquid fuel cartridge 150 in the first group 152 of outer liquid fuel cartridges may circumferentially neighbor at least one outer liquid fuel cartridge 150 in the second group 154 of outer liquid fuel cartridges 150 (as shown in FIGS. 3-5).

In many embodiments, the liquid fuel ejected from the first group 152 and the second group 154 may be combusted within the combustion chamber after being injected. At which point, the combustion gases may travel through the combustion liner 36 to the turbine section 18.

In optional embodiments, as shown in FIG. 10, the method 1000 may further include an optional step 1030 (indicated as optional by dashed box) of injecting a first jetted flow 188 of liquid fuel from each outer liquid fuel cartridge 150 in the first group 152 of outer liquid fuel cartridges at a first jetted angle 190. In many embodiments, the method 1000 may further include an optional step 1040 of injecting a second jetted flow 198 of liquid fuel from each outer liquid fuel cartridge 150 in the second group 154 of outer liquid fuel cartridges 150 at a second jetted angle 200. As discussed above, the first jetted angle 190 may different than the second jetted angle 200, such that the injection angles from the liquid fuel cartridges 150 may be different within the combustion chamber 37 depending arrangement and numbering of the first group 152 and the second group 154. The varying injection angles (e.g. the jetted angles 190, 200 of the jetted flow 188, 198 of liquid fuel) allow the combustor 17 to be able to operate on a wider range of water/liquid fuel mixtures without creating combustion dynamic issues within the combustor 17.

In many embodiments, each of the flows, e.g., the first central flow 182, the second central flow 192, the first jetted flow 188, and the second jetted flow 198, may be independently operable based on the load requirement of the gas turbine 10. For example, at low loads, only the central flows 182, 192 may be injected into the combustion zone 37 by the first and second groups 152, 154 of outer liquid fuel cartridges 150, while the jetted flows 188, 198 are turned off (or not being injected). At higher gas turbine 10 loads, the first group and the second group of outer liquid fuel cartridges 150 may inject all of the flows of liquid fuel, e.g., the first central flow 182, the second central flow 192, the first jetted flow 188, and the second jetted flow 198, into the combustion zone 37.

In exemplary embodiments, at low gas turbine 10 loads, the first central flow 182 and the second central flow 192 may be injected into the combustor 17 by the outer liquid fuel injectors 150 simultaneously and at varying angles, such that all 5 of the outer liquid fuel cartridges 150 are injecting the central flows 182, 192 at the same time. When the load requirement of the gas turbine 10 increases, the first jetted flow 188 and the second jetted flow 198 may begin to be injected by the outer liquid fuel cartridges 150 simultaneously and at varying angles (while still injecting the central flows 182, 192), such that all 5 of the outer liquid fuel cartridges 150 are injecting the central flows 182, 192 and the jetted flows 188, 198 at the same time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method of operating a combustor in a turbomachine, the combustor comprising a plurality of outer fuel nozzles circumferentially arranged on an end cover and a plurality of outer liquid fuel cartridges arranged in a first group of outer liquid fuel cartridges and a second group of outer liquid fuel cartridges, the method comprising:
injecting a first central flow of liquid fuel from a first pilot tip of each outer liquid fuel cartridge in the first group of outer liquid fuel cartridges into a combustion zone at a first central angle defined with respect to an axial centerline of each respective outer liquid fuel cartridge in the first group of outer liquid fuel cartridges; and
injecting a second central flow of liquid fuel from a second pilot tip of each outer liquid fuel cartridge in the second group of outer liquid fuel cartridges into the combustion zone at a second central angle defined with respect to an axial centerline of each respective outer liquid fuel cartridge in the second group of outer liquid fuel cartridges, wherein the first central angle is different than the second central angle.

2. The method as in claim 1, wherein the injecting a first central flow step and the injecting a second central flow step occur simultaneously.

3. The method as in claim 1, wherein the injecting of the first central flow of liquid fuel produces a first conical spray; and
wherein the first central angle is between about 35° and about 45°.

4. The method as in claim 1, wherein the injecting of the second central flow of liquid fuel produces a second conical spray; and
wherein the second central angle is between about 20° and about 37.5°.

5. The method as in claim 1, wherein the first central flow of liquid fuel exits each outer liquid fuel cartridge in the first group of outer liquid fuel cartridges from a first central outlet defined in the first pilot tip, and wherein the second central flow of liquid fuel exits each outer liquid fuel cartridge in the second group of outer liquid fuel cartridges from a second central outlet defined in the second pilot tip.

6. The method as in claim 1, wherein each outer liquid fuel cartridge in the first group of outer liquid fuel cartridges circumferentially neighbors at least one outer liquid fuel cartridge in the second group of outer liquid fuel cartridges.

7. The method as in claim 1, further comprising injecting a first jetted flow of liquid fuel from each outer liquid fuel cartridge in the first group of outer liquid fuel cartridges at a first jetted angle.

8. The method as in claim 7, wherein the first jetted angle is defined between the axial centerline of each respective outer liquid fuel cartridge in the first group of outer liquid fuel cartridges and the first jetted flow of liquid fuel, and wherein the first jetted angle is between about 45° and about 65°.

9. The method as in claim 7, further comprising injecting a second jetted flow of liquid fuel from each outer liquid fuel cartridge in the second group of outer liquid fuel cartridges at a second jetted angle.

10. The method as in claim 9, wherein the second jetted angle is defined between the axial centerline of each respective outer liquid fuel cartridge in the second group of outer liquid fuel cartridges and the second jetted flow of liquid fuel, and wherein the second jetted angle is between about 65° and about 85°.

11. The method as in claim 9, wherein the second jetted angle is different than the first jetted angle.

12. The method as in claim 9, wherein the first central angle, the second central angle, the first jetted angle, and the second jetted angle are each different from one another.

13. The method as in claim 9, wherein the first jetted flow of liquid fuel exits each outer liquid fuel cartridge in the first group of outer liquid fuel cartridges from a plurality of first peripheral outlets defined in the respective first pilot tips, the plurality of first peripheral outlets surrounding a first central outlet defined in the respective first pilot tips, and wherein the second jetted flow of liquid fuel exits each outer liquid fuel cartridge in the second group of outer liquid fuel cartridges from a plurality of second peripheral outlets defined in the respective second pilot tip, the plurality of second peripheral outlets surrounding a second central outlet defined in the respective second pilot tips.

14. A combustor comprising:
an end cover;
a combustion liner defining a combustion chamber;
a plurality of outer fuel nozzles circumferentially arranged and extending between the end cover and the combustion liner;
a plurality of outer liquid fuel cartridges each extending from a respective flange coupled to the end cover through a respective outer fuel nozzle of the plurality of outer fuel nozzles to one of a first pilot tip or a second pilot tip, wherein a first group of outer liquid fuel cartridges includes the first pilot tip and a second group of outer liquid fuel cartridges includes the second pilot tip, wherein the first pilot tip defines a first central outlet configured to inject liquid fuel into the combustion zone at a first central angle, wherein the second pilot tip defines a second central outlet configured to inject liquid fuel into the combustion zone at a second central angle, and wherein the first central angle is different than the second central angle.

15. The combustor as in claim 14, wherein each outer fuel nozzle in the first group of outer fuel nozzles directly circumferentially neighbors at least one outer fuel nozzle in the second group of outer fuel nozzles.

16. The combustor as in claim 15, wherein each respective first pilot tip defines a plurality of first peripheral outlets that surround the first central outlet of the first pilot tip, and wherein each respective second pilot tip defines a plurality of second peripheral outlets that surround the second central outlet of the second pilot tip.

17. The combustor as in claim 16, wherein the first plurality of peripheral outlets are configured to inject a first jetted flow of liquid fuel into the combustion chamber at a first jetted angle, and wherein the second plurality of peripheral outlets are configured to inject a second jetted flow of liquid fuel into the combustion chamber at a second jetted angle.

18. The combustor as in claim 17, wherein the first jetted angle is different than the second jetted angle.

19. The combustor as in claim 17, wherein the first central angle is between about 35° and about 45°, and wherein the first jetted angle is between about 45° and about 65°.

20. The combustor as in claim 17, wherein the second central angle is between about 20° and about 37.5°, and wherein the second jetted angle is between about 65° and about 85°.
